(19) United States
(12) Patent Application Publication
(10) Pub. No.: US 2018/0121292 A1
(43) Pub. Date: May 3, 2018

(54) SYSTEMS AND METHODS FOR DATABASE MANAGEMENT

(71) Applicant: MasterCard International Incorporated, Purchase, NY (US)

(72) Inventors: Srinivas Kosaraju, Wildwood, MO (US); Sundar Varanasi, Grover, MO (US); Devendran A. Sriramanane, Grover, MO (US); Vikranth Kumar Anneboina, Dardenne Prairie, MO (US)

(21) Appl. No.: 15/341,912

(22) Filed: Nov. 2, 2016

(51) Int. Cl. G06F 11/14; G06F 17/30

(52) U.S. Cl. CPC G06F 11/1451; G06F 11/1464; G06F 17/30477; G06F 2201/80; G06F 17/30867; G06F 17/3053; G06F 11/1461

(57) ABSTRACT

A database management (DM) computing device for managing a database is provided. The DM computing device accesses log data to determine the frequency that data fields of one or more full databases are queried. The DM computing device ranks the data fields based on the number of times each has been queried and determines the most frequently requested data fields. The DM computing device then copies the most frequently requested data fields to one or more secondary databases. The DM computing device analyzes subsequent queries to determine whether they may be satisfied by the data fields contained in the reduced database and executes any such queries against the reduced database as opposed to the full database. In certain embodiments, the DM computing device copies data from the full database to the reduced database according to a predetermined schedule or during a low-traffic time determined by the DM computing device from the log data.

### BACKGROUND

The field of the disclosure relates generally to database management and, more particularly, to a method and system for identifying frequently queried database fields within a database table, and improving the performance of the database based upon identifying such database fields.

In at least some known databases, each table entry within a database may include a large number of searchable database fields. For example, databases used in the financial industry may include fields such as transaction amount, date, time, identifiers, cardholder information, merchant information, etc. The databases may be searchable by user queries submitted to the database that enable a user to filter, sort, and search for particular entries within the database based on database fields. As the database receives additional data and new entries, the performance of the database may be reduced. For example, the database may respond to user queries with an increased delay because such user queries must be run against an increased set of data entries. In at least some known databases, database performance is also dependent on the number of user queries received by the database. For example, database performance may be significantly reduced during high-traffic time periods such as regular business hours of businesses within a particular geographic region. Faced with such performance issues, operators of databases often must choose between offering clients poor database performance or investing additional capital and resources to upgrade their database systems.

Oftentimes, a large percentage of user queries are directed to the same or similar data corresponding to a small percentage of the database fields. Accordingly, running user queries against all database fields of a database is both inefficient and unnecessary. Therefore, systems and methods are needed that identify user queries corresponding to frequently requested data fields and execute such user queries against only a subset of the database data fields corresponding to the frequently requested data fields.

### BRIEF DESCRIPTION OF THE DISCLOSURE

In one aspect, a database management (DM) computing device is disclosed. The DM computing device includes one or more processors in communication with one or more memory device and is configured to: access log data stored in the memory, the log data identifying a number of times database fields of one or more full database tables have been queried; rank the database fields of the full database tables based on the number of times the database fields of the full database tables have been queried; identify most used database fields from the ranked database fields; and copy to one or more reduced database tables the most used database fields.

In another aspect, a computer-implemented method for database management is disclosed. The method is implemented using a DM computing device in communication with the database. The method includes: accessing, by the DM computing device, log data stored in the memory, the log data identifying a number of times database fields of one or more full database tables have been queried; ranking, by the DM computing device, the database fields of the full database tables based on the number of times the database fields of the full database tables have been queried; identifying, by the DM computing device, most used database fields from the ranked database fields; and copying, by the DM computing device, to one or more reduced database tables the most used database fields.

In yet another aspect, a computer-readable storage medium having computer-executable instructions embodied thereon is provided. When executed by a device authentication computing device having one or more processors in communication with one or more memory devices, the computer-executable instructions cause the fraud detection computing device to: access log data stored in the memory, the log data identifying a number of times database fields of one or more full database tables have been queried; rank the database fields of the full database tables based on the number of times the database fields of the full database tables have been queried; identify most used database fields from the ranked database fields; and copy to one or more reduced database tables the most used database fields.

### BRIEF DESCRIPTION OF THE DRAWINGS

FIGS. 1-4 show example embodiments of the device and method described herein.

FIG. 1 illustrates an example configuration of a data management (DM) computing device in accordance with an exemplary embodiment of the present disclosure.

FIG. 2 illustrates an example configuration of a DM system 200 including a DM computing device, such as the DM computing device of FIG. 1.

FIG. 3 illustrates a flow diagram showing a method for reducing the number of database fields stored within an reduced database to increase the performance of the reduced database.

FIG. 4 illustrates an example list of database fields ranked by the number of user queries submitted to the database for each database field.

### DETAILED DESCRIPTION OF THE DISCLOSURE

The systems and methods described herein relate generally to generating reduced databases tables from one or more full database tables based on frequently queried database fields of the full database tables. The methods and systems include a database management (DM) computing device including a processor coupled to one or more memories. As described in detail below, the DM computing device is configured to analyze log data corresponding to the frequency that one or more database fields of one or more full database tables are queried. The log data analyzed by the DM computing device may correspond to data collected over a predefined time period (e.g., previous 7 years) and may identify a number of times database fields of one or more full database tables have been queried. Based on the frequencies indicated in the log data, the DM computing device ranks each database field within the full database tables by the number of user queries submitted that request each database field. For example, there may be more user queries for a database field including transaction amounts as compared to a database field including cardholder residence addresses. Therefore, the database field for transaction amounts would be ranked higher than the database field for cardholder residence addresses. Based on the ranking of the log data, the DM computing device identifies the most used database fields (i.e., the most frequently requested data fields of the one or more full database tables), and copies the most used database fields into one or more reduced database tables. Because the reduced database tables include a copy of the most used database fields of the full database tables, subsequent queries requesting data from one or more of the most used database fields are run against the reduced database tables instead of the full database tables. By doing so, the amount of data against which subsequent queries are run is minimized, improving the overall efficiency of executing the query. In the example embodiment, each of the reduced database tables is also maintained on a faster, more expensive data warehouse platform such as a Netezza® data warehouse (Netezza® is a registered trademark of Netezza Corporation, an IBM Company) or an Exadata® data warehouse (Exadata® is a registered trademark of Oracle International Corporation). Doing so further improves the efficiency with which subsequent queries may be executed.

The DM computing device ranks the database fields by the number of user queries per database field and identifies the most used database fields. In the example embodiment, the most used database fields are defined as the database fields that are the most queried by users pursuant to a predefined threshold (e.g., the top 60% of the most queried database fields). In an alternative embodiment, the DM computing device is configured to identify the least frequently used database fields based upon the user queries (e.g., the bottom 40% of the most frequently queried database fields) and to consider the remaining database fields to be the most used database fields. In alternative embodiments, the most used database fields are defined as database fields that have been queried at least a predetermined number of times and/or that have been queried by at least a predetermined number of users.

In certain embodiments, the DM computing device copies the most used database fields into the reduced database tables by generating a query from the ranked list of database fields. The DM computing device then executes the query against the one or more full database tables to extract data from the relevant database fields for copying to the reduced database tables.

The DM computing device may copy the most used database fields to the reduced database tables according to a schedule in which such copying occurs during particular time periods. In certain embodiments, the DM computing device may copy the most used database fields to the reduced database tables at a regular predetermined time. For example, the DM computing device may be configured to copy the most used database fields on one of a monthly, weekly, or daily basis. The DM computing device may be further configured to copy the most used database fields at a particular time of day, for example, after normal business hours in the geographic region from which the DM computing device receives the most user queries.

The DM computing device may schedule copying of the most used database fields to the reduced database tables according to the log data corresponding to the frequency that one or more database fields of the full database tables are queried. For example, the DM computing device may rank a set of time periods based on the frequency of user queries within each time period. The DM computing device may then identify one or more low-traffic time periods having historically low query traffic and may schedule copying of the most used database fields during the low-traffic time periods. In such embodiments, the DM computing device may periodically reevaluate the copying schedule to account for changes in user query demand.

When the DM computing device receives a query requesting one or more database fields of the full database tables, the DM computing device may determine whether the query can be satisfied by the data stored in the reduced database tables. If so, the DM computing device may execute the query against the reduced database tables. Because the reduced database tables generally include only a subset of the full database tables, the amount of database fields scanned during execution of the query is reduced, thereby improving the query runtime and overall system performance. Any remaining data fields requested as part of the query may then be retrieved from the full database tables.

In certain embodiments, the DM computing device may be further configured to transmit at least a portion of the reduced database tables to one or more client computing devices. For example, the DM computing device may automatically send data retrieved from the reduced database tables to a subscriber on a regular basis such that the subscriber is able to maintain an up-to-date copy of the data. Such copies may be used by the subscriber to generate reports, perform statistical analyses, and the like.

Data copied by the DM computing device to the reduced database tables may be filtered or otherwise limited based on one or more parameters. For example, in certain embodiments, the DM computing device may only copy data to the reduced database tables that corresponds to transactions within a specific country or other geographic region. As another example, the DM computing device may only copy data to the reduced database tables corresponding to transactions made with a particular payment card product, meeting a certain dollar amount threshold, involving particular classes of products or services, and the like. As yet another example, the DM computing device may only copy data associated with a particular entity including, but not limited to, a merchant, a merchant bank, an issuing bank, or a payment processor.

The methods and systems described herein may be implemented using computer programming or engineering techniques including computer software, firmware, hardware or any combination or subset thereof, wherein the technical effects may be achieved by performing one of the following steps: (a) accessing, by the DM computing device, log data stored in the memory, the log data identifying a number of times database fields of a database table have been queried; (b) ranking, by the DM computing device, the database fields of the database table based on the number of times the database fields of the database table have been queried; (c) identifying, by the DM computing device, most used database fields from the ranked database fields; and (d) copying, by the DM computing device, to a secondary storage database the most used database fields.

The technical benefits achieved by the methods and systems described herein include: (a) reducing an amount of database fields and data stored within a data warehouse, i.e., the reduced database tables, and scanned during a user query, thereby improving query runtime; (b) improving an overall system performance as a result of reducing the amount of database fields stored within the data warehouse; (c) increasing a bandwidth of the network for processing database queries by generally improving the overall speed of the query runtime; and (d) increasing the overall speed and efficiency of the network.

The following detailed description illustrates embodiments of the invention by way of example and not by way of limitation. It is contemplated that the invention has general application to processing financial transaction data by a third party in a variety of applications.

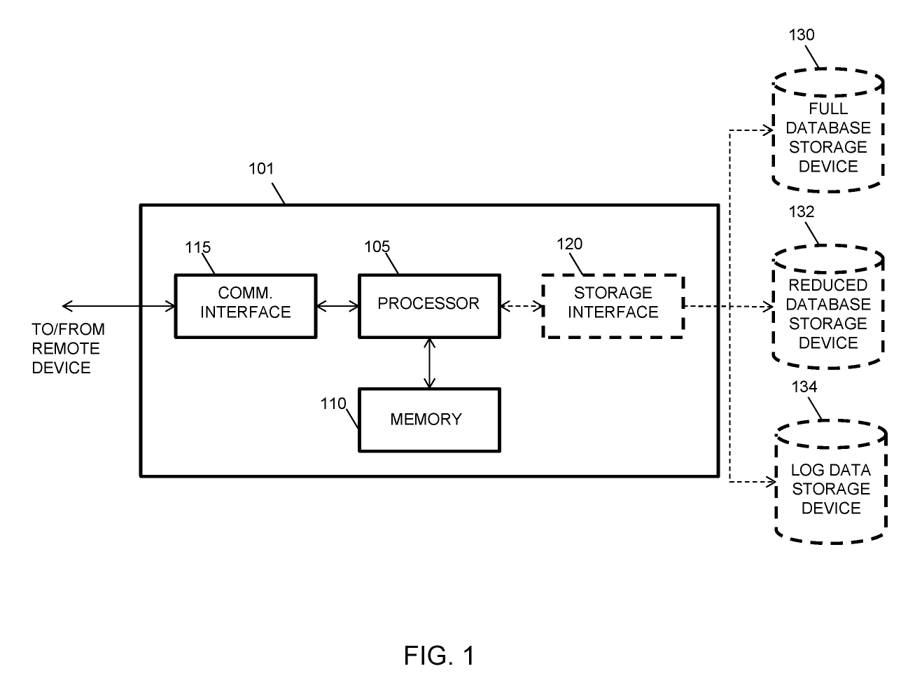

FIG. 1 illustrates an example configuration of a DM computing device 101. DM computing device 101 includes a processor 105 for executing instructions. Instructions may be stored in a memory area 110, for example. Processor 105 may include one or more processing units (e.g., in a multi-core configuration) for executing instructions. The instructions may be executed within a variety of different operating systems on the server system 101, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 105 is operatively coupled to a communication interface 115 such that DM computing device 101 is capable of communicating with one or more remote devices including, but not limited to, external storage devices, client computing devices, and other computing devices.

Processor 105 may also be operatively coupled to one or more storage devices, including, full database storage device 130, reduced database storage device 132, and log data storage device 134. Each of full database storage device 130, reduced database storage device 132, and log data storage device 134 may be any computer-operated hardware suitable for storing and/or retrieving data. In some embodiments, one or more of full database storage device 130, reduced database storage device 132, and log data storage device 134 are integrated in DM computing device 101. For example, DM computing device 101 may include one or more hard disk drives as any of full database storage device 130, reduced database storage device 132, and log data storage device 134. In other embodiments, full database storage device 130, reduced database storage device 132, and log data storage device 134 are external to DM computing device 101 and may be accessed by a plurality of DM computing devices. For example, each of full database storage device 130, reduced database storage device 132, and log data storage device 134 may include multiple storage units such as hard disks or solid state disks in a redundant array of inexpensive disks (RAID) configuration. Full database storage device 130, reduced database storage device 132, and log data storage device 134 may include a storage area network (SAN) and/or a network attached storage (NAS) system.

In general, full database storage device 130 stores a first data set in one or more full database tables while reduced database storage device 132 stores a second data set in one or more reduced database tables, the second data set containing a subset of data stored in the first data set. More specifically, full database storage device 130 contains one or more database fields and reduced database storage device 132 contains a copy of the most used database fields of full database storage device 130. In the example embodiment, reduced database storage device 132 corresponds to a faster, more expensive data warehouse platform as compared to full database storage device 130. Such platforms may include, but are not limited to a Netezza® data warehouse or an Exadata® data warehouse

To determine which of the one or more database fields are the most used, DM computing device 101 may generate and store log data in log data storage device 134. For example, during operation DM computing device 101 may receive user queries requesting data stored in full database storage device 130. Such queries will generally be directed to data contained in one or more database fields of the full database tables. Accordingly, as DM computing device 101 receives and processes such user queries, DM computing device 101 may generate a log entry containing one or more of the date/time of the user query, the database fields implicated by the user query, and the like. DM computing device 101 may then analyze the log entries contained in log data to determine which of the database fields stored in full database storage device 130 correspond to the most used or most frequently requested by user queries. DM computing device 101 may then coordinate copying of the most used database fields to reduced database storage device 132.

In some embodiments, processor 105 is operatively coupled to each of full database storage device 130, reduced database storage device 132, and log data storage device 134 via a storage interface 120. Storage interface 120 is any component capable of providing processor 105 with access to each of full database storage device 130, reduced database storage device 132, and log data storage device 134. Storage interface 120 may include, for example, an Advanced Technology Attachment (ATA) adapter, a Serial ATA (SATA) adapter, a Small Computer System Interface (SCSI) adapter, a redundant array of inexpensive disks (RAID) controller, a storage area network (SAN) adapter, a network adapter, and/or any component providing processor 105 with access to each of full database storage device 130, reduced database storage device 132, and log data storage device 134.

Memory area 110 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

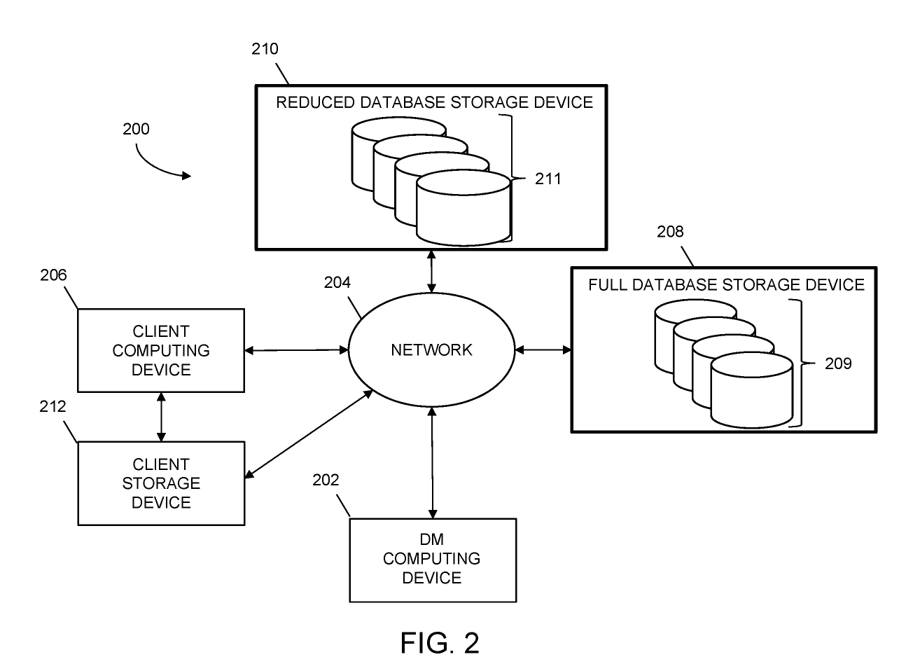

FIG. 2 is a schematic illustration of an example configuration of a database management (DM) system 200. DM system 200 includes DM computing device 202, which may correspond to DM computing device 101 of FIG. 1, a client computing device 206, a full database storage device 208, and a reduced database storage device 210, which are connected to each other via a network 204. Network 204 may include the Internet, an interchange network for payment card transactions, and/or one or more other networks. For example, a connection between the computing devices may include a wireless network, a wired network, a telephone network, a cable network, a combination thereof, and the like. Examples of a wireless network include networks such as WiFi, WiMAX, WiBro, local area network, personal area network, metropolitan area network, cellular, Bluetooth, and the like.

Each of full database storage device 208 and reduced database storage device 210 include one or more data sources. For example, full database storage device 208 includes full databases 209 and reduced storage device 210 includes reduced databases 211. Each of full databases 209 and reduced databases 211 may include one or more database tables, each including one or more database fields for storing data. In certain embodiments, for example, full databases 209 may store transaction data related to payment card transactions. Reduced databases 211 generally store a subset of the data stored in full databases 209. For example, reduced databases 211 may contain only the most frequently accessed database fields of full databases 209.

In DM system 200, each of full database storage device 208 and reduced database storage device 210 are depicted as separate computing devices communicatively coupled over network 204. In other embodiments, full database storage device 208 and reduced database storage device 210 may be incorporated into the same computing device. In still other embodiments, full database storage device 208 and reduced database storage device 210 may be combined with DM computing device 202 into one computing device.

During operation, DM computing device 202 accesses log data corresponding to queries directed to full database storage device 208. Such queries may be submitted by client devices, such as client computing device 206. In certain embodiments, log data may be stored in an internal memory of DM computing device 202, such as memory 110 of FIG. 1. In other embodiments, log data may be stored in an external storage device communicatively coupled to DM computing device 202 over network 204, such as log data storage device 134 of FIG. 1. DM computing device 202 analyzes the log data to determine which data fields of full databases 209 are most frequently queried. For example, DM computing device 202 may rank each data field of full databases 209 based on the number of queries directed thereto and identify the highest ranked data fields. DM computing device 202 then copies the most frequently queried data fields to reduced databases 211. To do so, DM computing device 202 may generate a query from the log data and execute the query against full databases 209.

In certain embodiments, DM computing device 202 may limit data copied from full databases 209 to reduced databases 211 according to one or more filters. For example, in the context of payment card transaction data, DM computing device 202 may copy only data corresponding to transactions that: (i) occurred within a particular geographic region (e.g., country), (ii) were made using a particular payment card product, (iii) involved certain entities (e.g., cardholders, merchants, merchant banks, issuing banks, payment processors), or (iv) involved the purchase of particular classes of goods or services.

DM computing device 202 may copy data fields from full databases 209 to reduced databases 211 according to a predetermined schedule. For example, DM computing device 202 may be configured to perform copying on a daily, weekly, bi-weekly, or other recurring basis. In certain embodiments, DM computing device 202 may dynamically determine an optimal time to perform copying. To do so, DM computing device 202 may access the log data and determine the number of queries submitted during a set of time periods. DM computing device 202 may rank each time period in the set of time periods based on the number of queries and identify time periods having relatively low query traffic. DM computing device 202 may then schedule copying for one or more of the low-traffic time periods. To account for changes in query traffic, DM computing device 202 may periodically re-analyze the log data and determine a new time period during which copying may be performed.

Client computing device 206 may be any suitable computing device configured to communicate and receive data over network 204. Client computing device 206 is generally configured to submit queries to be executed against full databases 209. DM computing device 202 may receive such queries and determine whether the query, in whole or in part, is directed to data fields that have been copied to reduced databases 211. If the query is directed entirely to data fields in reduced databases 211, DM computing device 202 directs the query to be executed against reduced database storage device 210 instead of full database storage device 208. If the query is directed only in part to data fields in reduced databases 211, DM computing device 202 may parse the query into a first query corresponding to the data fields in full databases 209 and a second query corresponding to the data fields in reduced databases 209. DM computing device 202 may then direct the first and second queries to full database storage device 208 and reduced database storage device 210, respectively.

DM computing device 202 may transmit or “push” at least a portion of the data fields contained in reduced databases 211 to a tertiary storage device, such as client storage device 212. Client storage device 212 may be incorporated into or communicatively coupled to client computing device 206. In certain embodiments, the data fields transmitted and stored in client storage device 212 may be a subset of the data fields contained in reduced databases 211 corresponding to the data fields that are most frequently queried by client computing device 206. The data in client storage device 212 may also be limited to only data that is relevant to client computing device 206. Client computing device 206 may query data contained in client storage device 212 instead of submitting queries to either of full databases 209 or reduced databases 211. Moreover, client computing device 206 may use the data stored in client storage device 212 to generate reports and/or perform various analytics. In certain embodiments, DM computing device 202 may transmit data to client storage device 212 based on a subscription. For example, a user may use client computing device 206 to request to receive certain data fields from DM computing device 202 according to a particular schedule.

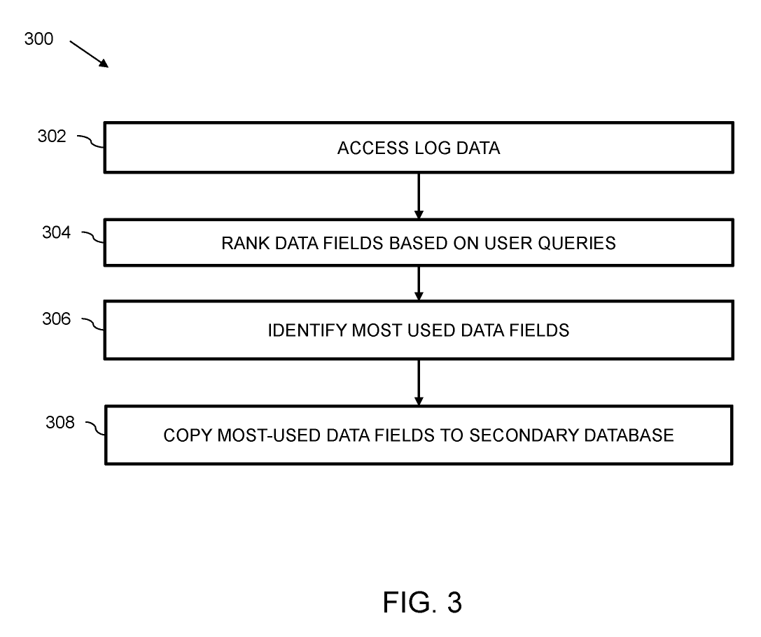

FIG. 3 is a flow diagram 300 showing a method for database management. The methods and systems include a DM computing device, such as DM computing device 101 of FIG. 1, communicatively coupled to a full database and a reduced database containing a copy of a subset of database fields of the full database.

The DM computing device is configured to access 302 log data from a memory device coupled to the DM computing device. The log data identifies a number of times database fields of a database table have been queried. The DM computing device is further configured to rank 304 each database field within the one or more database tables based on user queries for each database field. The DM computing device is configured to identify 306 the most used data fields most frequently retrieved in response to user queries. The DM computing device is further configured to copy 308 the most used database fields to the reduced database.

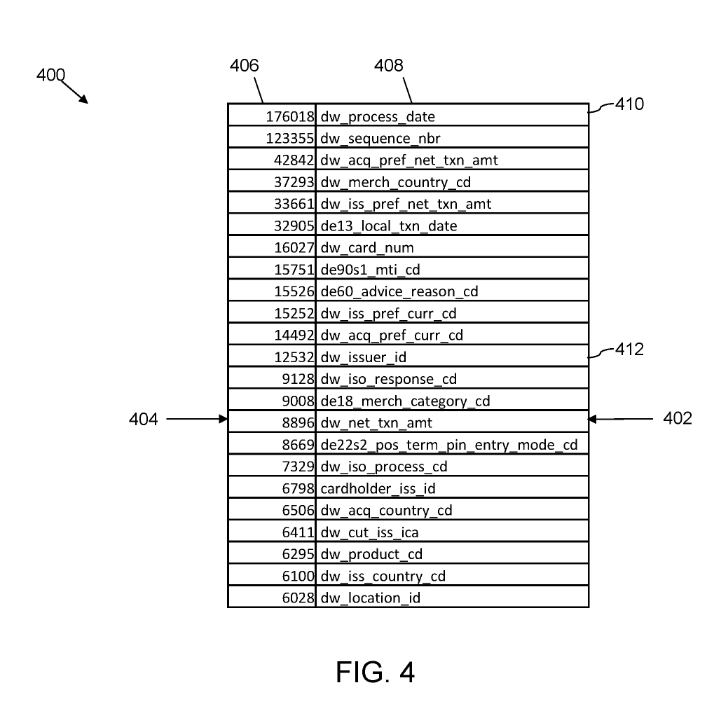

FIG. 4 illustrates an example list 400 of database fields 402 ranked by the number of user queries 404 submitted to the database for each database field 402. A first column 406 is the number of user queries 404 for an associated database field 402 included in the same row. A second column contains database fields 402. Database fields 402 are ranked by number of user queries 404 from highest to lowest.

The DM computing device is configured to generate list 400 from log data accessed from a memory device. The log data identifies a number of times database fields 402 of a database table have been queried. The DM computing device is configured to rank each database field 402 by the number of user queries 404 submitted to the database for each database field 402. For example, there may be more user queries 404 for a database field 402 for a process date (i.e., “dw_process_date” 410) as compared to a database field for an issuer ID (i.e., “dw_issuer_id” 412). Therefore, the database field for process date would be ranked higher than the database field for issuer ID.

Any processor in a computing device referred to herein may refer to one or more processors wherein the processor may be in one DM computing device or a plurality of DM computing devices acting in parallel. Additionally, any memory in a computing device referred to herein may also refer to one or more memories wherein the memories may be in one DM computing device or a plurality of DM computing devices acting in parallel.

As used herein, a processor may include any programmable system including systems using micro-controllers, reduced instruction set circuits (RISC) processors, application specific integrated circuits (ASIC) processors, logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The system is flexible and designed to run in various different environments without compromising any major functionality. In some embodiments, the system includes multiple components distributed among a plurality of DM computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

Computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “card,” “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment for performing a transaction. In addition, consumer card account behavior can include, but is not limited to, purchases, management activities (e.g., balance checking), bill payments, achievement of targets (meeting account balance goals, paying bills on time), and/or product registrations (e.g., mobile application downloads).

One or more computer-readable storage media may include computer-executable instructions embodied thereon for maintaining account-on-file information. In this example, the DM computing device may include a memory device and a processor in communication with the memory device, and when executed by said processor, the computer-executable instructions may cause the processor to perform a method, such as the methods described and illustrated in the examples of FIG. 3.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example, the system is executed on a single computer system, without a connection to a server computer. In a further example, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A database management (DM) computing device, said DM computing device comprising one or more processors in communication with one or more memory device, said DM computing device configured to:
access log data stored in the memory, the log data identifying a number of times database fields of one or more full database tables have been queried;
rank the database fields of the full database tables based on the number of times the database fields of the full database tables have been queried;
identify most used database fields from the ranked database fields; and
copy to one or more reduced database tables the most used database fields.

2. The DM computing device in accordance with claim 1, wherein the DM computing device is further configured to generate at least one query corresponding to the most used database fields, wherein copying to the reduced database tables includes executing the at least one query against the full database tables.

3. The DM computing device in accordance with claim 1, wherein the DM computing device is further configured to:
rank one or more time periods based on the number of times the full database tables were queried during each time period; and
identify one or more least-used time periods from the ranked time periods, wherein the one or more least-used time periods correspond to time periods during which the full database tables were least frequently queried and wherein copying to the reduced database tables occurs during the one or more least-used time periods.

4. The DM computing device in accordance with claim 1, wherein the DM computing device is further configured to:
receive a query corresponding to one or more of the most used database fields; and
redirect the query to the reduced database tables.

5. The DM computing device in accordance with claim 1, wherein the DM computing device is further configured to transmit at least a portion of the reduced database tables to one or more client storage devices.

6. The DM computing device in accordance with claim 1, wherein copying to the reduced database tables occurs according to a predetermined schedule.

7. The DM computing device in accordance with claim 1 further configured to filter data contained in the database fields based on one or more of (i) a geographic region associated with the data; (ii) a product associated with the data; and (iii) an entity associated with the data.

8. A computer-implemented method for database management, the method implemented using a database management (DM) computing device in communication with the database, the DM computing device including a processor and a memory, said method comprising:
accessing, by the DM computing device, log data stored in the memory, the log data identifying a number of times database fields of one or more full database tables have been queried;
ranking, by the DM computing device, the database fields of the full database tables based on the number of times the database fields of the full database tables have been queried;
identifying, by the DM computing device, most used database fields from the ranked database fields; and
copying, by the DM computing device, to one or more reduced database tables the most used database fields.

9. The method in accordance with claim 8, wherein copying to the reduced database tables further comprises:
generating, by the DM computing device, at least one query corresponding to the most used database fields; and
executing, by the DM computing device, the at least one query against the full database tables.

10. The method in accordance with claim 8 further comprising:
ranking, by the DM computing device, one or more time periods based on the number of times the full database tables were queried during each time period; and
identifying, by the DM computing device, one or more least-used time periods from the ranked time periods, wherein the one or more least-used time periods correspond to time periods during which the full database tables were least frequently queried and wherein the DM computing device copies the most used database fields during the one or more least-used time periods.

11. The method in accordance with claim 8 further comprising:
receiving a query corresponding to one or more of the most used database fields; and
redirecting the query to the reduced database tables.

12. The method in accordance with claim 8 further comprising transmitting at least a portion of the reduced database tables to one or more client storage devices.

13. The method in accordance with claim 8, wherein copying to the reduced database tables occurs according to a predefined schedule.

14. The method in accordance with claim 8, further comprising filtering data contained in the database fields based on one or more of (i) a geographic region associated with the data; (ii) a product associated with the data; and (iii) an entity associated with the data.

15. A computer-readable storage medium having computer-executable instructions embodied thereon, wherein when executed by a device authentication computing device having one or more processors in communication with one or more memory devices, the computer-executable instructions cause the device authentication computing device to:
access log data stored in the memory, the log data identifying a number of times database fields of one or more full database tables have been queried;
rank the database fields of the full database tables based on the number of times the database fields of the full database tables have been queried;
identify most used database fields from the ranked database fields; and
copy to one or more reduced database tables the most used database fields.

16. The computer readable medium in accordance with claim 15, wherein the computer-executable instructions cause the DM computing device to generate at least one query corresponding to the most used database fields, wherein copying to the reduced database tables further comprises executing the at least one query against the database table.

17. The computer readable medium in accordance with claim 15, wherein the computer-executable instructions cause the DM computing device to:
rank one or more time periods based on the number of times the full database tables were queried during each time period; and
identify one or more least-used time periods from the ranked time periods, wherein the one or more least-used time periods correspond to time periods during which the full database tables were least frequently queried and wherein copying to the reduced database tables occurs during the one or more least-used time periods.

18. The computer readable medium in accordance with claim 15, wherein the computer-executable instructions cause the DM computing device to:
receive a query corresponding to one or more of the most used database fields; and
redirect the query to the reduced database tables.

19. The computer readable medium in accordance with claim 15, wherein the computer-executable instructions cause the DM computing device to transmit at least a portion of the reduced database tables to one or more client data sources.

20. The computer readable medium in accordance with claim 15, wherein the computer-executable instructions cause the DM computing device to filter data contained in the database fields based on one or more of (i) a geographic region associated with the data; (ii) a product associated with the data; and (iii) an entity associated with the data.
